(19) United States
(12) Patent Application Publication
(10) Pub. No.: US 2019/0286128 A1
(43) Pub. Date: Sep. 19, 2019

(54) VEHICLE CONTROLLING APPARATUS AND VEHICLE

(71) Applicant: HONDA MOTOR CO., LTD., Tokyo (JP)

(72) Inventors: Toshiyuki KAJI, Wako-shi (JP); Takashi WATANABE, Wako-shi (JP)

(21) Appl. No.: 16/282,840

(22) Filed: Feb. 22, 2019

(30) Foreign Application Priority Data
Mar. 16, 2018 (JP) 2018-049879

(51) Int. Cl. G05D 1/00; B60W 50/08

(52) U.S. Cl. CPC G05D 1/0061; B60W 2540/22; G05D 1/0088; B60W 50/082

(57) ABSTRACT

A control apparatus for controlling a vehicle is provided. The control apparatus includes a travel control unit capable of controlling travel of the vehicle in any of a travel states in accordance with a circumstance of the vehicle and an acquisition unit configured to acquire a movement of a driver of the vehicle. The travel states include a first travel state and a second travel state that is higher in a degree of automation or lower in a driver task than the first travel state. The movement of the driver includes a first movement prohibited in the first travel state and allowed in the second travel state. A condition for determining whether to execute travel control in the second travel state includes an execution state of the first movement or an operation state of the vehicle that relates to the first movement.

### CROSS-REFERENCE TO RELATED APPLICATION(S)

This application claims the benefit of Japanese Patent Application No. 2018-049879, filed on Mar. 16, 2018, the entire disclosure of which is incorporated herein by reference.

### BACKGROUND OF THE INVENTION

### Field of the Invention

The present invention relates to a vehicle controlling apparatus and a vehicle.

### Description of the Related Art

Techniques for automatically driving a vehicle such as a four-wheel vehicle (so-called automated driving techniques) have been increasingly developed. The control system disclosed in Japanese Patent Laid-Open No. 2017-207907 provides automated driving in a plurality of levels in accordance with the environment of the vehicle. Specifically, automated driving is performed in a mode A of a highest level, a mode B of an intermediate level, or a mode C of a lowest level. The higher the level, the smaller the task to be imposed on the user. For example, while a task of monitoring the surroundings is imposed on the driver in the mode A, the task of monitoring the surroundings is not imposed on the driver in the modes B and C.

### SUMMARY OF THE INVENTION

The control system disclosed in Japanese Patent Laid-Open No. 2017-207907 automatically performs a transition when a transition to a higher level can be performed. Consequently, the level is switched against the intention of the driver, and a notification is given to the driver every time when such switching is performed. An aspect of the present invention is to provide a technique of performing transitions of the travel state as intended by the driver.

According to an embodiment of the present invention, a control apparatus for controlling a vehicle, the control apparatus comprising: a travel control unit capable of controlling travel of the vehicle in any of a plurality of travel states in accordance with a circumstance of the vehicle; and an acquisition unit configured to acquire a movement of a driver of the vehicle, wherein the plurality of travel states include a first travel state and a second travel state that is higher in a degree of automation or lower in a driver task than the first travel state, the movement of the driver includes a first movement, the first movement being prohibited in the first travel state and allowed in the second travel state, and a condition for determining whether to execute travel control in the second travel state includes an execution state of the first movement or an operation state of the vehicle that relates to the first movement is provided.

Further features of the present invention will become apparent from the following description of exemplary embodiments with reference to the attached drawings.

### BRIEF DESCRIPTION OF THE DRAWINGS

FIG. 1 is a block diagram illustrating an exemplary configuration of a vehicle according to an embodiment.

FIG. 2 is a block diagram illustrating an exemplary operation of a control apparatus according to the embodiment.

### DESCRIPTION OF THE EMBODIMENTS

Embodiments of the present invention are described below with reference to the accompanying drawings. In the embodiments, identical components are denoted with the same reference symbols, and repetitive descriptions are omitted. In addition, the embodiments may be modified and combined.

A vehicle 1 includes a vehicle controlling apparatus 2 (hereinafter referred to simply as “control apparatus 2”) that controls the vehicle 1. The control apparatus 2 includes a plurality of ECUs 20 to 29 that are connected with each other via an in-vehicle network such that they can communicate with each other. Each ECU includes a processor typified by a CPU, a memory such as a semiconductor memory, an interface for an external device and the like. The memory stores programs executed by the processor, data used by the processor for processes and the like. Each ECU may include a plurality of processors, memories, interfaces and the like. For example, the ECU 20 includes a processor 20a and a memory 20b. When an order included in a program stored in the memory 20b is executed by the processor 20a, a process is executed by the ECU 20. Alternatively, the ECU 20 may include a dedicated integrated circuit such as an ASIC for executing a process of the ECU 20. The same applies to other ECUs.

The functions and the like of the ECUs 20 to 29 are described below. Note that the number and the functions of the ECUs may be appropriately designed, and may be further subdivided or combined in comparison with the present embodiment.

The ECU 20 executes a control relating to automated driving of the vehicle 1. In the automated driving, the steering and/or acceleration/deceleration of the vehicle 1 is automatically controlled. In the exemplary control described later, both the steering and the acceleration/deceleration are automatically controlled.

The ECU 21 controls an electric power steering apparatus 3. The electric power steering apparatus 3 includes a mechanism that steers the front wheel in accordance with a driving operation of a steering wheel 31 (steering operation) performed by the driver. The electric power steering apparatus 3 also includes a motor that generates a driving force for assisting the steering operation and automatically steering the front wheel, a sensor that detects the steering angle, and the like. When the vehicle 1 is in an automated driving state, the ECU 21 automatically controls the electric power steering apparatus 3 in response to an instruction from the ECU 20, and controls the travel direction of the vehicle 1.

The ECUs 22 and 23 control detection units 41 to 43 that detect the circumstances surrounding the vehicle, and the ECUs 22 and 23 perform information processing on a detection result. The detection unit 41 is a camera (hereinafter referred to also as camera 41) that captures an image of the front side of the vehicle 1, and, in the present embodiment, the detection unit 41 is attached on the vehicle interior side of the front window in a front portion of a roof of the vehicle 1. By analyzing the image captured by the camera 41, the outline of the target and a divisional line (such as a white line) of a lane on the road can be extracted.

The detection unit 42 is a light detection and ranging (LIDAR) (hereinafter referred to also as LIDAR 42). The detection unit 42 detects a target around the vehicle 1 and measures the distance from a target. In the present embodiment, five LIDARs 42 are provided at the front and rear corners of the vehicle 1 and at a center of the rear part of the vehicle 1. The detection unit 43 is a millimeter-wave radar (hereinafter referred to also as radar 43). The detection unit 43 detects a target around the vehicle 1 and measures the distance from a target. In the present embodiment, five radars 43 are provided at a center of the front part of the vehicle 1 and at the front and rear corners of the vehicle 1.

The ECU 22 controls one camera 41 and each LIDAR 42 and performs information processing on a detection result. The ECU 23 controls the other camera 41 and each radar 43 and performs information processing on a detection result. The reliability of the detection result can be improved with two pairs of apparatuses for detecting the circumstances surrounding the vehicle, and a many-sided analysis of the circumstances surrounding the vehicle can be performed with the detection units of different types including the cameras, the LIDARs, and the radars.

An ECU 24 controls a gyro sensor 5, a GPS sensor 24b and a communication apparatus 24c and performs information processing on a detection result or a communication result. The gyro sensor 5 detects a rotational movement of the vehicle 1. The advancing direction of the vehicle 1 can be determined based on a detection result of the gyro sensor 5, the wheel speed and the like. The GPS sensor 24b detects the present position of the vehicle 1. The communication apparatus 24c performs radio communication with a server for providing map information and traffic information to acquire the map information and the traffic information. The ECU 24 can access a database 24a of map information created in the memory, and the ECU 24 performs a route search from the present position to the destination, and the like. The ECU 24, the map database 24a and the GPS sensor 24b constitute a so-called navigation apparatus.

An ECU 25 includes a communication apparatus 25a for inter-vehicle communications. The communication apparatus 25a performs radio communication with other vehicles in the surrounding region to exchange information between the vehicles.

An ECU 26 controls a power plant 6. The power plant 6 is a mechanism that outputs a driving force for rotating the driving wheel of the vehicle 1, and includes an engine and a transmission, for example. The ECU 26 controls the engine output in accordance with a driving operation of the driver (an accelerator operation or an acceleration operation) detected by an operation detection sensor 7a provided in an accelerator pedal 7A, and switches the gear ratio of the transmission on the basis of information such as the vehicle speed detected by a vehicle speed sensor 7c, for example. When the vehicle 1 is in an automated driving state, the ECU 26 automatically controls the power plant 6 in response to an instruction from the ECU 20, and controls the acceleration and the deceleration of the vehicle 1.

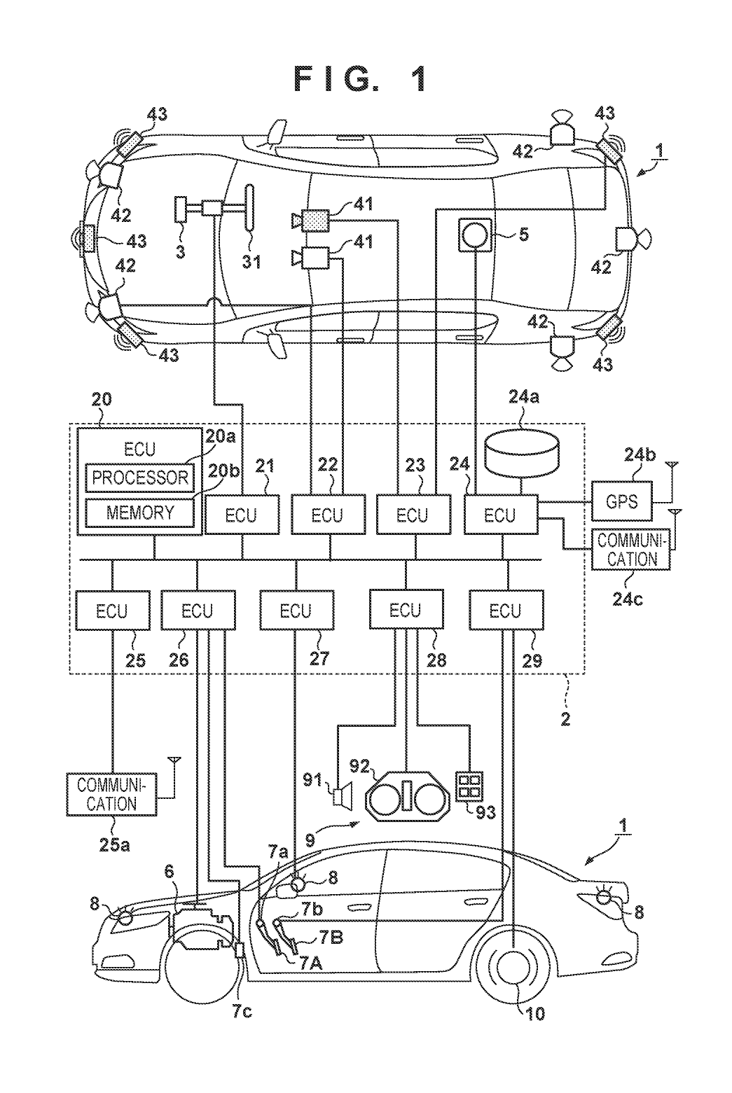

The ECU 27 controls lighting devices (such as a head light and a tail light) including directional indicators 8 (blinker). In the example illustrated in FIG. 1, the directional indicators 8 are provided at the front part, the door mirror and the rear part of the vehicle 1.

The ECU 28 controls an input/output apparatus 9. The input/output apparatus 9 outputs information to the driver and receives information from the driver. A sound output apparatus 91 notifies the driver of information by means of sound. A display device 92 notifies the driver of information by displaying an image. The display device 92 is disposed in a front face of the driver's seat and constitutes an instrument panel and the like. While sound and image display are exemplified here, vibration and/or light may be used for notification of information. Alternatively, any combination of sound, display, vibration and light may be used for notification. Further, the combination and/or the notification mode may be changed in accordance with the level (e.g. the degree of urgency) of the information to be notified. An input apparatus 93, which is a switch group disposed at a position where it can be operated by the driver and configured to give an instruction to the vehicle 1, may include a sound input apparatus. The ECU 28 can provide guidance relating to the travel control of the ECU 20. Details of the guidance is described later. The input apparatus 93 may include a switch used for controlling the operation of the travel control of the ECU 20. The input apparatus 93 may include a camera for detecting the eye direction of the driver.

The ECU 29 controls a brake apparatus 10 and/or a parking brake (not illustrated in the drawing). The brake apparatus 10 is a disk brake apparatus, and is provided for each wheel of the vehicle 1, for example. The brake apparatus 10 exerts a resistance on the rotation of the wheel to decelerate or stop the vehicle 1. The ECU 29 controls the operation of the brake apparatus 10 in accordance with a driving operation (brake operation) of the driver detected by an operation detection sensor 7b provided in a brake pedal 7B, for example. When the vehicle 1 is in an automated driving state, the ECU 29 automatically controls the brake apparatus 10 in response to an instruction from the ECU 20, and controls deceleration and stoppage of the vehicle 1. The brake apparatus 10 and/or the parking brake may operate to maintain the stopping state of the vehicle 1. In addition, in the case that the transmission of the power plant 6 has a parking lock mechanism, the mechanism may operate to maintain the stopping state of the vehicle 1.

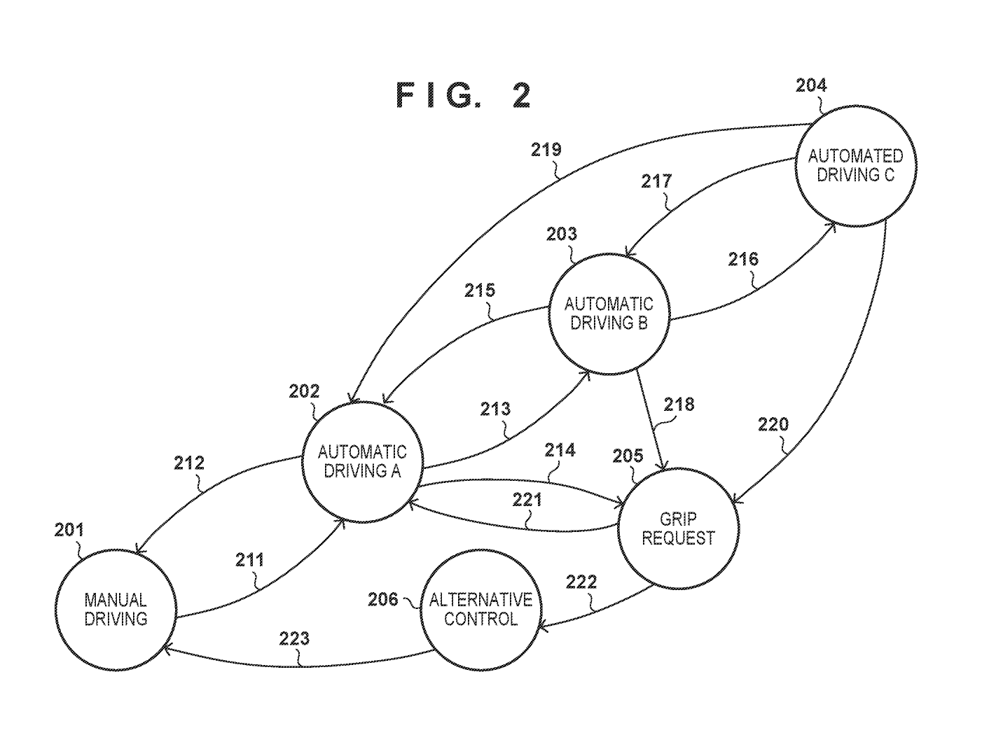

Now an exemplary operation of the control apparatus 2 is described with reference to a state transition diagram of FIG. 2. In FIG. 2, states of the control apparatus 2 are indicated with circles, and transitions of states are indicated with arrows. In each state, the control apparatus 2 repeatedly determines whether the transition condition is satisfied.

A state 201 indicates a state that the driver of the vehicle 1 is performing manual driving. States 202 to 204 indicate travel states that the control apparatus 2 is performing travel control of the vehicle 1 by automated driving. The control apparatus 2 (e.g. the ECU 20) can control the travel of the vehicle 1 in any of a plurality of travel states in accordance with the circumstance of the vehicle 1. The circumstance of the vehicle 1 includes the environment around the vehicle 1 (e.g. the type of the road on which the vehicle is traveling, the state of the road surface, the weather condition, the positional relationships with other vehicles around the vehicle, and the like) and/or the state of the vehicle 1 (the vehicle speed, the acceleration, the amount of remaining gasoline or power, and the like). A starting state of the vehicle 1 is the state 201, for example.

The state 202 is a state that the driver is required to grip the steering wheel and to monitor the surroundings. The automated driving in this state is referred to as an automated driving A. The operator in the state 202 is the driver. In the state 202, only a vertical-direction control or a lateral-direction control of the vehicle 1 may be performed, or both the vertical-direction control and the lateral-direction control may be performed. The vertical-direction control is, for example, an adaptive cruise control (ACC), and the lateral direction control is, for example, a lane keeping assistant system (LKAS). In the state 202, merge/separation to or from a highway main lane is performed, for example. The state 203 is a state that the driver is not required to grip the steering wheel and the driver is required to monitor the surroundings. The automated driving in this state is referred to as an automated driving B. The operator in the state 203 is the driver. In the state 203, for example, the vehicle control is performed on a highway main lane that is not congested. The state 204 is a state that the driver is not required to grip the steering wheel or to monitor the surroundings. Note that, in order to be ready for a warning notification of a malfunction of the vehicle system, the driver is required to monitor the vehicle system. The automated driving in this state is referred to as an automated driving C. The operator of the vehicle 1 in the state 204 is the control apparatus 2. In the state 204, for example, a traffic jam pilot (TJP) for following the vehicle travelling ahead on a congested highway main lane is performed. That is, the degree of the automation of the state 203 is higher than that of the state 202, and the degree of the automation of the state 204 is higher than that of the state 203. In addition, the driver task of the state 203 is lower than that of the state 202, and the driver task of the state 204 is lower than that of the state 203. The driver task is a task required for the driving, and includes gripping of the steering wheel and monitoring of the surrounding region, for example.

A state 205 is a state that the control apparatus 2 is requesting the driver to grip the steering wheel. For example, the control apparatus 2 makes a request for gripping the steering wheel by giving a message requesting gripping of the steering wheel by a display on the display device 92 and/or by an output from the sound output apparatus 91. This request may be made regardless of whether the driver is gripping the steering wheel. A state 206 is a state that the control apparatus 2 is executing alternative control. The alternative control is a control of decelerating the vehicle 1 for a transition to a safe state while sending a request of driving change to the driver.

A transition 211 indicates a transition from the state 201 (manual driving) to the state 202 (the automated driving A). The control apparatus 2 performs this transition when the vehicle 1 is in a circumstance that the travel control in the automated driving A can be executed and the driver has requested a start of automated driving. For example, the control apparatus 2 determines that the travel control in the automated driving A can be executed when the vehicle 1 is traveling on a highway. When the driver requests a start of automated driving in a circumstance that the travel control in the automated driving A cannot be executed, the control apparatus 2 does not perform the transition 211 and notifies the driver that automated driving cannot be started.

A transition 212 indicates a transition from the state 202 (the automated driving A) to the state 201 (manual driving). The control apparatus 2 performs this transition when the circumstance of the vehicle 1 is changed to a circumstance that the state 202 (the automated driving A) cannot be maintained, or when the driver has requested termination of the automated driving.

A transition 213 indicates a transition from the state 202 (the automated driving A) to the state 203 (the automated driving B). The control apparatus 2 performs this transition when the vehicle 1 is in a circumstance that the travel control in the automated driving B can be executed. Even when the driver is gripping the steering wheel, the control apparatus 2 may perform the transition 213 when there is no large steering input. When the driver stops the grip on the steering wheel in a circumstance that the travel control in the automated driving B cannot be executed, the control apparatus 2 does not perform the transition 213, and requests the driver to grip the steering wheel.

A transition 214 indicates a transition from the state 202 (the automated driving A) to the state 205 (grip request). The control apparatus 2 performs this transition when the vehicle 1 is in a circumstance that the travel control in the automated driving B cannot be executed and the driver stops grip on the steering wheel.

A transition 215 indicates a transition from the state 203 (the automated driving B) to the state 202 (the automated driving A). The control apparatus 2 performs this transition when the driver has started to grip the steering wheel.

A transition 216 indicates a transition from the state 203 (the automated driving B) to the state 204 (the automated driving C). The control apparatus 2 performs this transition when the vehicle 1 is in a circumstance that the travel control in the automated driving C can be executed and the driver has started a movement that is prohibited in the state 203 and is allowed to be performed in the state 204, or when the vehicle 1 has started an operation relating to the movement. Such a movement includes a task that is not related to the travel of the vehicle 1 (so-called second task) such as an operation of a navigation, an operation of an audio apparatus, viewing of a television, an operation of a mobile terminal, reading, watching surrounding scenery, and looking at rear seat. The control apparatus 2 (e.g. an ECU 28) can acquire a movement of the driver of the vehicle 1 on the basis of an input to the input apparatus 93. The control apparatus 2 (e.g. the ECU 20) determines whether the acquired movement corresponds to the second task. Further, the driver can make a reservation for a start of a second task (e.g. a reservation for playing a movie) before the travel control in the automated driving C is started (e.g. prior to the start of driving). When the circumstance of the vehicle 1 is changed from a circumstance that the travel control in the automated driving C cannot be executed to a circumstance that the travel control in the automated driving C can be executed, the vehicle 1 starts an operation relating to the reserved second task. Accordingly, the control apparatus 2 starts the travel control in the automated driving C.

A transition 217 indicates a transition from the state 204 (the automated driving C) to the state 203 (the automated driving B). The control apparatus 2 performs this transition when the driver has stopped a movement that is prohibited in the state 203 and is allowed to be performed in the state 204, or when the vehicle 1 has stopped an operation relating to the movement. This movement includes the above-described second task. For example, this transition is performed when the driver has intentionally stopped the playback of a movie, or the playback of a movie has been finished.

A transition 218 indicates a transition from the state 203 (the automated driving B) to the state 205 (grip request). The control apparatus 2 performs this transition when the circumstance of the vehicle 1 is changed to a circumstance that the travel control in the automated driving B cannot be maintained, or when the driver has started a second task in a circumstance that the travel control in the automated driving C cannot be executed.

A transition 219 indicates a transition from the state 204 (the automated driving C) to the state 202 (the automated driving A). The control apparatus 2 performs this transition when the driver has started to grip the steering wheel.

A transition 220 indicates a transition from the state 204 (the automated driving C) to the state 205 (grip request). The control apparatus 2 performs this transition when the circumstance of the vehicle 1 is changed to a circumstance that the travel control in the automated driving C cannot be maintained.

A transition 221 indicates a transition from the state 205 (grip request) to the state 202 (the automated driving A). The control apparatus 2 performs this transition when the driver has responded to the grip request within a threshold time (e.g. 15 seconds) and started gripping the steering wheel.

A transition 222 indicates a transition from the state 205 (grip request) to the state 206 (alternative control). The control apparatus 2 performs this transition when the driver has not responded to the grip request within a threshold time (e.g. 15 seconds).

A transition 223 indicates a transition from the state 206 (alternative control) to the state 201 (manual driving). The control apparatus 2 performs this transition when the driver has started manual driving.

As described above, the condition for determining whether to execute the travel control in the state 204 (the automated driving C) (that is, the condition for a transition to the state 204 from another state, and the condition for a transition to another state from the state 204) includes the execution state of a movement (second task) that is prohibited in the state 203 (the automated driving B) and is allowed to be performed in the state 204 (the automated driving C) or the operation state of the vehicle relating to the movement. Therefore, the control apparatus 2 maintains the state 203 (the automated driving B) unless the driver starts the second task even in a circumstance that a transition from the state 203 (the automated driving B) to the state 204 (the automated driving C) can be performed. In addition, the control apparatus 2 performs a transition to the state 203 (the automated driving B) when the driver has stopped a second task even in a circumstance that the state 204 (the automated driving C) can be maintained. With this configuration, provision of high-level automated driving against the intention of the driver is suppressed. Further, a transition to the state 205 (grip request) is performed in the both cases that the travel state (the state 203 or the state 204) cannot be maintained due to a change in the circumstance of the vehicle 1, and thus the number of the patterns of the request to the driver can be reduced.

### SUMMARY OF THE EXEMPLARY EMBODIMENT

### Configuration 1

A control apparatus (2) for controlling a vehicle (1), the control apparatus including:

a travel control unit (20) capable of controlling travel of the vehicle in any of a plurality of travel states in accordance with a circumstance of the vehicle; and

an acquisition unit (28) configured to acquire a movement of a driver of the vehicle, wherein

the plurality of travel states include a first travel state (203) and a second travel state (204) that is higher in a degree of automation or lower in a driver task than the first travel state,

the movement of the driver includes a first movement, the first movement being prohibited in the first travel state and allowed in the second travel state, and

a condition for determining whether to execute travel control in the second travel state includes an execution state of the first movement or an operation state of the vehicle that relates to the first movement.

With this configuration, transitions of the travel state can be performed as intended by the driver. As a result, unnecessary notifications to the driver can be reduced.

### Configuration 2

The control apparatus according to configuration 1, wherein a condition for a transition from the first travel state to the second travel state includes a fact that the driver starts the first movement or the vehicle starts an operation relating to the first movement.

With this configuration, a transition to travel control that does not require a task of monitoring the surroundings can be performed on a condition that the driver has started a second task.

### Configuration 3

The control apparatus according to configuration 1 or 2, wherein a condition for a transition from the second travel state to the first travel state includes a fact that the driver stops the first movement or the vehicle stops an operation relating to the first movement.

With this configuration, a transition to travel control that does not require a task of monitoring the surroundings can be performed on a condition that the driver has stopped a second task.

### Configuration 4

The control apparatus according to any one of configurations 1 to 3, wherein the travel control unit requests the driver to perform a second movement in a same manner both when the circumstance of the vehicle is changed to a circumstance that the first travel state cannot be maintained and when the circumstance of the vehicle is changed to a circumstance that the second travel state cannot be maintained.

With this configuration, the same movement is requested in accordance with a change in the circumstance of the vehicle regardless of whether the task of monitoring the surroundings is required, and thus it is possible to reduce the complexity felt by the driver.

### Configuration 5

The control apparatus according to any one of configurations 1 to 4, wherein

the first travel state is a state that the driver is not required to grip a steering wheel and the driver is required to monitor surroundings, and

the second travel state is a state that the driver is not required to grip the steering wheel and the driver is not required to monitor the surroundings.

With this configuration, transitions of the travel state can be performed based on the execution state of a second task that can be performed while the monitoring of the surrounding region is not required.

### Configuration 6

The control apparatus according to any one of configurations 1 to 5, wherein when the circumstance of the vehicle is changed to a circumstance that the second travel state cannot be maintained, the travel control unit requests the driver to grip a steering wheel.

With this configuration, it is possible to request grip on the steering wheel in a travel state that does not impose the task of monitoring the surroundings.

### Configuration 7

A vehicle (1) including the control apparatus according to any one of configurations 1 to 6.

With this configuration, transitions of the travel state can be performed as intended by the driver.

What is claimed is:

1. A control apparatus for controlling a vehicle, the control apparatus comprising:
a travel control unit capable of controlling travel of the vehicle in any of a plurality of travel states in accordance with a circumstance of the vehicle; and
an acquisition unit configured to acquire a movement of a driver of the vehicle, wherein
the plurality of travel states include a first travel state and a second travel state that is higher in a degree of automation or lower in a driver task than the first travel state,
the movement of the driver includes a first movement, the first movement being prohibited in the first travel state and allowed in the second travel state, and
a condition for determining whether to execute travel control in the second travel state includes an execution state of the first movement or an operation state of the vehicle that relates to the first movement.

2. The control apparatus according to claim 1, wherein a condition for a transition from the first travel state to the second travel state includes a fact that the driver starts the first movement or the vehicle starts an operation relating to the first movement.

3. The control apparatus according to claim 1, wherein a condition for a transition from the second travel state to the first travel state includes a fact that the driver stops the first movement or the vehicle stops an operation relating to the first movement.

4. The control apparatus according to claim 1, wherein the travel control unit requests the driver to perform a second movement in a same manner both when the circumstance of the vehicle is changed to a circumstance that the first travel state cannot be maintained and when the circumstance of the vehicle is changed to a circumstance that the second travel state cannot be maintained.

5. The control apparatus according to claim 1, wherein
the first travel state is a state that the driver is not required to grip a steering wheel and the driver is required to monitor surroundings, and
the second travel state is a state that the driver is not required to grip the steering wheel and the driver is not required to monitor the surroundings.

6. The control apparatus according to claim 1, wherein when the circumstance of the vehicle is changed to a circumstance that the second travel state cannot be maintained, the travel control unit requests the driver to grip a steering wheel.

7. A vehicle comprising the control apparatus according to claim 1.
